(19) United States
(12) Patent Application Publication
(10) Pub. No.: US 2014/0265914 A1
(43) Pub. Date: Sep. 18, 2014

(54) LIGHT FIXTURE COLOR ROAMING TECHNIQUES

(71) Applicant: NII NORTHERN INTERNATIONAL INC., Markham (CA)

(72) Inventor: Frederic Boucher, Delson (CA)

(73) Assignee: Nii Northern International Inc., Markham (CA)

(21) Appl. No.: 13/841,123

(22) Filed: Mar. 15, 2013

(51) Int. Cl. H05B 33/08

(52) U.S. Cl. CPC H05B 33/0857
USPC 315/291

(57) ABSTRACT

A method for operating a light fixture in a lighting system includes receiving an instruction. If the instruction includes a broad spectrum signal, the roaming range may be set to a broad spectrum. If the instruction includes a first range signal, roaming range may be set to a first range of the broad spectrum. If the instruction includes a second range signal, roaming range may be set to a second range of the broad spectrum. A light having a spectral peak may be generated, and a wavelength of the spectral peak may be varied within the roaming range.

### CROSS REFERENCE TO RELATED APPLICATIONS

Not applicable

### FEDERALLY SPONSORED RESEARCH OR DEVELOPMENT

Not applicable

### JOINT RESEARCH AGREEMENT

Not applicable

### SEQUENCE LISTING

Not applicable

### BACKGROUND

Generally, this application relates to lighting systems. In particular, this application relates to lighting systems with controllable color.

Certain outdoor light fixtures can emit a variety of different colors. It is possible to dynamically cycle or change the color of light emitted by a color-emitting light fixture. One such dynamic changing of color may be termed “roaming.” Roaming may refer to an automatic and gradual transition between two or more colors.

Outdoor light fixtures are often arranged to emit light onto a target. Such targets may include landscape features, such as vegetation, water, or ground. Other targets may include man-made structures, such as buildings. Different targets may have different colors or textures.

It has been observed that, when light of a particular color is projected onto a target of a different color, often the illumination of the target results in an unpleasing or perceptually incongruent color. For example, looking at FIG. 1, it can be seen that shining a red light onto a green target may result in an unpleasing resulting color (for example, pinkish or grayish). It can also be seen that shining a blue-green light onto a green target may result in a pleasing resulting color (for example, a vivid color more closely resembling the native color of the target).

It may be desirable to provide lighting systems that are designed to avoid creating unpleasing resulting colors on targets.

### SUMMARY

According to certain inventive techniques, a method for operating a light fixture in a lighting system includes receiving an instruction. For example, a wireless (for example, infrared) signal may be received. If the instruction includes a broad spectrum signal, the roaming range may be set to a broad spectrum (for example, approximately red to approximately bluish-pink). If the instruction includes a first range signal, roaming range may be set to a first range of the broad spectrum (for example, approximately yellowish-green to approximately bluish-green). If the instruction includes a second range signal, roaming range may be set to a second range (for example, approximately cyan to approximately bluish-pink or approximately red to approximately orange) of the broad spectrum. A light having a spectral peak may be generated, and a wavelength of the spectral peak may be varied within the roaming range. For example, at least three different-colored LEDs may be controlled. If the instruction includes a third range signal, roaming range may be set to a third range (for example, approximately cyan to approximately bluish-pink or approximately red to approximately orange) of the broad spectrum.

If the instruction includes a first color signal, the spectral peak may be adjusted to a substantially constant wavelength corresponding to the first color. If the instruction includes a second color signal, the spectral peak may be adjusted to a substantially constant wavelength corresponding to the second color.

According to certain inventive techniques, a light fixture includes a plurality of different-colored lamps and a control portion. The control portion may be configured to receive an instruction. If the instruction includes a broad spectrum signal, the control portion may be configured to set a roaming range to a broad spectrum (for example, approximately red to approximately bluish-pink). If the instruction includes a first range signal, the control portion may be configured to set the roaming range to a first range (for example, approximately yellowish-green to approximately bluish-green) of the broad spectrum. If the instruction includes a second range signal, the control portion may be configured to set the roaming range to a second range of the broad spectrum (for example, approximately cyan to approximately bluish-pink or approximately red to approximately orange). The control portion may be configured cause the plurality of lamps to generate together a light having a spectral peak. The control portion may also be configured to cause the plurality of lamps to together vary a wavelength of the spectral peak within the roaming range. If the instruction includes a third range signal, roaming range may be set to a third range (for example, approximately cyan to approximately bluish-pink or approximately red to approximately orange) of the broad spectrum.

If the instruction includes a first color signal, the spectral peak may be adjusted to a substantially constant wavelength corresponding to the first color. If the instruction includes a second color signal, the spectral peak may be adjusted to a substantially constant wavelength corresponding to the second color.

The light fixture may also include a receiver that receives a wireless communication that includes the instruction. The receiver may responsively communicate the instruction with the control portion.

### BRIEF DESCRIPTION OF SEVERAL VIEWS OF THE DRAWINGS

FIG. 1 illustrates a light fixture shining a red or blue-green light at a green target.

FIG. 2A illustrates a lighting system, according to inventive techniques.

FIG. 2B illustrates a user interface for a remote control, according to inventive techniques.

FIG. 3 illustrates a broad visible light spectrum and three narrower ranges of the visible light spectrum, according to inventive techniques.

FIG. 4 illustrates a flowchart of a method for operating a light fixture, according to inventive techniques.

The foregoing summary, as well as the following detailed description of certain inventive techniques, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

FIG. 2 illustrates a lighting system 10, according to inventive techniques. The lighting system 10 may include a light fixture 100, a remote control 200, and a power supply 300. The lighting system 10 may include two or more light fixtures 100. Each light fixture 100 may be controllable by the remote 200.

The light fixture 100 may be a deck light, a spot light, a tape light, or the like. The light fixture 100 may include two or more colored lamps 110, a control portion 120, a receiver 130, and a user interface 140. The two or more colored lamps 110 may include two or more corresponding light emitting diodes (“LEDs”) having different colors. For example, there may be three colored lamps 110—a blue LED, a green LED, and a red LED. There may be groups of LEDs as well. For example, there may be 5 LEDs of each color grouped together. Different colors can be mixed to obtain a resulting color. For example, red and blue can be turned on to make purple. The colored lamps 110 may be driven to create different intensity light outputs to cause dimming or brightening or to adjust the shade of the mixed color.

The colored lamps 110 may be controlled by the control portion 120. The control portion 120, for example, may control the intensity of light emitted from each colored lamp 110 or group of colored lamps 110. For example, the control portion 120 may independently control the intensity of light emitted from the colored lamps 110. As an illustrative example, assume there is a group of blue LEDs, a group of green LEDs, and a group of red LEDs. The control portion 120 may independently control each group of LEDs separately from the other groups.

The receiver 130 may receive wireless signals from the remote 200. The wireless signals may be, for example, an infrared, Wi-Fi, cellular, or any other of a variety of wireless signal types. The receiver 130 may decode information sent wirelessly from the remote 200 and transmit the decoded information to the control portion 120. The decoded information sent to the control portion 120 may influence the operation of the control portion or provide instructions to the control portion on how to vary the illumination of the colored lamps 110. The light fixture 100 may also include a transmitter (not shown) that transmits wireless signals from the light fixture 100 to the remote 200 or other light fixtures 100.

The user interface 140 may include, for example, one or more switches or other user interface devices. The operation of the control portion 120 may be influenced by the state or change of state of the user interface devices or signals.

The remote control 200 may include a user interface 210 and a transmitter 220. The user interface 210 may include one or more switches or other user interface devices. The transmitter 220 may transmit one or more wireless signals (for example, infrared, WiFi, cellular, or the like) based on the state or change of state of the user interface devices. For example, the transmitter 220 may transmit different commands in response to a user pressing different switches in the user interface 210.

The power supply 300 may supply operating power to the light fixture 100. The power supply 300 may be remotely located from the light fixture 100, or located on the light fixture 100. The power supply 300 may be an AC/DC, AC/AC, or DC/DC power supply. The power supply 300 may convert a relatively high voltage (for example, 120 VAC) to a low voltage (for example, 16 VDC). The power supply 300 may include a rechargeable battery. The power supply 300 may also include a solar cell and a rechargeable battery.

The system of 10 may be configured and operated as follows. The user interface 210 on the remote control 200 may include a plurality of buttons as shown in FIG. 2B. The user interface 210 may cause the transmitter 220 to transmit a wireless signal including one or more instructions to the receiver 130. The receiver 130 may communicate the instruction(s) to the control portion 120, which may, in turn, control the colored lamps 110 accordingly. Each button on the user interface 210 may include a momentary contact switch that is detected and a corresponding instruction is generated and transmitted by the transmitter 220.

Exemplary instructions corresponding to the user interface buttons are as follows. The OFF button may generate an OFF instruction to turn off the colored lamps 110. The Color 1-Color 8 buttons may generate corresponding instructions to set the overall mixed color of the colored lamps 110 to eight distinct, static colors (for example, warm white, cyan, green, cool white, blue, red, pink, or purple). Obtaining the desired color by color mixing may be achieved by adjusting the intensity of the different lamps 110 and/or switching one or more of the lamps 110 on/off. For example, purple may be achieved by turning off green lights and turning on red and blue lights. For each color, the color mixing may result in a different corresponding spectral peak having a substantially constant wavelength.

The buttons entitled Broad Range, First Range, Second Range, and Third Range may generate roaming instructions as explained below. The Broad Range button may generate a Broad Spectrum Roaming instruction. Referring to FIG. 3, a broad spectrum may include a range between approximately red to approximately bluish-pink. The Broad Spectrum Roaming instruction may cause the mixed color of the colored lamps 110 to change relatively smoothly and gradually across a broad spectrum. The roaming may go back and forth, for example, from approximately red to approximately bluish-pink and then back to approximately red. The broad spectrum roaming may take place over a period of time (for example, 1 minute to roam starting with approximately red and ending with approximately bluish-pink). The roaming pattern may repeat itself. Thus, when performing broad spectrum roaming, a light having a spectral peak may be generated and the wavelength of the spectral peak may be varied within the broad spectrum.

The First Range button may generate a First Range Roaming instruction. The First Range Roaming instruction may cause the mixed color of the colored lamps 110 to change relatively smoothly and gradually across only a first range of the broad spectrum. As shown in FIG. 3, the first range may be between approximately red and approximately orange. The roaming may go back and forth, for example, from approximately red to approximately orange and then back to approximately red. The first range roaming may take place over a period of time (for example, 1 minute to roam starting with approximately red and ending with approximately orange). The roaming pattern may repeat itself. Thus, when performing first range roaming, a light having a spectral peak may be generated and the wavelength of the spectral peak may be varied within the first range.

The Second Range button may generate a Second Range Roaming instruction. The Second Range Roaming instruction may cause the mixed color of the colored lamps 110 to change relatively smoothly and gradually across only a second range of the broad spectrum. As shown in FIG. 3, the second range may be between approximately yellowish-green and approximately bluish-green. The roaming may go back and forth, for example, from approximately yellowish-green to approximately bluish-green and then back to approximately yellowish-green. The second range roaming may take place over a period of time (for example, 1 minute to roam starting with approximately yellowish-green and ending with approximately bluish-green). The roaming pattern may repeat itself. Thus, when performing second range roaming, a light having a spectral peak may be generated and the wavelength of the spectral peak may be varied within the second range.

The Third Range button may generate a Third Range Roaming instruction. The Third Range Roaming instruction may cause the mixed color of the colored lamps 110 to change relatively smoothly and gradually across only a third range of the broad spectrum. As shown in FIG. 3, the third range may be between approximately cyan and approximately bluish-pink. The roaming may go back and forth, for example, from approximately cyan to approximately bluish-pink and then back to approximately cyan. The third range roaming may take place over a period of time (for example, 1 minute to roam starting with approximately cyan and ending with approximately bluish-pink). The roaming pattern may repeat itself. Thus, when performing third range roaming, a light having a spectral peak may be generated and the wavelength of the spectral peak may be varied within the third range.

A user may choose the first, second, or third range based on the color of the object or objects to be illuminated. If a red object (for example, a brick wall) is to be illuminated, then the exemplary first roaming range described above may avoid unpleasing color combinations. If a green object (for example, vegetation such as a tree) is to be illuminated, then the exemplary second roaming range described above may avoid unpleasing color combinations. If a blue object is to be illuminated (for example, a fountain), then the exemplary third roaming range described above may avoid unpleasing color combinations.

The DIM button may generate a DIM instruction to dim the intensity of one or more colored lamps 110 (for example, drive the lamps at 20 percent of full value). Dimming may be performed without changing color shade. The dimming instruction may be applicable to both the static colors and the roaming colors. The BRITE button may generate a BRIGHT instruction to set the intensity of the one or more colored lamps 110 to a higher level (for example, drive the lamps at 100 percent). The color shade may remain the same when the intensity is brought up to the bright level. The bright instruction may be applicable to both the static colors and the roaming colors.

The 5-hour button may generate an instruction to cause the colored lamps 110 to switch ON right away and to switch OFF automatically 5 hours later. After another 19 hours, the colored lamps 110 may switch ON again. This process may repeat itself, thereby creating a 24 hour cycle during which the colored lamps are on for 5 hours and off for 19 hours. When switching the lamps back ON again, the previous state (for example, solid color, roaming color, dim, or bright) of the lamps 110 may be recalled from a value stored in memory and re-implemented.

The 10-hour button may generate an instruction to cause the colored lamps 110 to switch ON right away and to switch OFF automatically 10 hours later. After another 14 hours, the colored lamps 110 may switch ON again. This process may repeat itself, thereby creating a 24 hour cycle during which the colored lamps are on for 10 hours and off for 14 hours. When switching the lamps back ON again, the previous state (for example, solid color, roaming color, dim, or bright) of the lamps 110 may be recalled from a value stored in memory and re-implemented. While the examples of 5 hours and 10 hours have been given, it may be possible to set the repeating duty cycle to any length of time (for example, 4 hours ON and 20 hours OFF, or the like).

The Auto Shut-Off button may generate an instruction to cause the colored lamps 110 to switch ON right away and to switch OFF automatically after a period of time (for example, 8 hours). This function, however, may not repeat like the functions performed in response to the 5-hour button instruction and the 10-hour button instruction.

FIG. 4 illustrates a flowchart 400 of a method for operating a light fixture, according to inventive techniques. The method may be performed, for example, by a system such as system 10. At step 410, a roaming instruction is received. At step 420, it is determined whether the roaming instruction is for a first range, a second range, or a broad spectrum. If the roaming instruction is for a broad spectrum, then a light with changing color is emitted by roaming across a broad spectrum at step 430. If the roaming instruction is for a first range, then a light with changing color is emitted by roaming across only a first range of the broad spectrum at step 440. If the roaming instruction is for a first range, then a light with changing color is emitted by roaming across only a second range of the broad spectrum at step 450.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method for operating a light fixture in a lighting system, the method comprising:
receiving an instruction;
if the instruction comprises a broad spectrum signal, setting a roaming range to a broad spectrum;
if the instruction comprises a first range signal, setting the roaming range to a first range of the broad spectrum;
if the instruction comprises a second range signal, setting the roaming range to a second range of the broad spectrum, wherein the second range is different than the first range; and
if the instruction comprises at least one of the broad spectrum signal, the first range, signal, or the second range signal:
generating a light having a spectral peak, and
varying a wavelength of the spectral peak within the roaming range.

2. The method of claim 1, wherein the first range of the broad spectrum comprises approximately yellowish-green to approximately bluish-green.

3. The method of claim 1, wherein the second range of the broad spectrum comprises at least one of:
approximately cyan to approximately bluish-pink, or
approximately red to approximately orange.

4. The method of claim 1, wherein:
the first range of the broad spectrum comprises approximately yellowish-green to approximately bluish-green; and
the second range of the broad spectrum comprises at least one of:
approximately cyan to approximately bluish-pink, or
approximately red to approximately orange.

5. The method of claim 1, further comprising:
if the instruction comprises a third range signal, setting the roaming range to a third range of the broad spectrum; and
varying a wavelength of the spectral peak within the roaming range.

6. The method of claim 5, wherein the third range of the broad spectrum comprises at least one of:
approximately cyan to approximately bluish-pink, or
approximately red to approximately orange.

7. The method of claim 5, wherein:
the first range of the broad spectrum comprises yellowish-green to approximately bluish-green; and
the second range of the broad spectrum comprises approximately cyan to approximately bluish-pink; and
the third range of the broad spectrum comprises approximately red to approximately orange.

8. The method of claim 1, further comprising:
if the instruction comprises a first color signal, adjusting the spectral peak to a substantially constant wavelength corresponding to the first color, and
if the instruction comprises a second color signal, adjusting the spectral peak to a substantially constant wavelength corresponding to the second color.

10. The method of claim 1, wherein said receiving an instruction comprises receiving a wireless communication.

11. The method of claim 10, wherein the wireless communication comprises an infrared communication.

12. The method of claim 1, wherein said generating a light comprises individually controlling illumination of at least three different-colored LEDs.

13. A light fixture comprising:
a plurality of lamps including different colors;
a control portion configured to:
receive an instruction;
if the instruction comprises a broad spectrum signal, set a roaming range to a broad spectrum;
if the instruction comprises a first range signal, set the roaming range to a first range of the broad spectrum;
if the instruction comprises a second range signal, set the roaming range to a second range of the broad spectrum, wherein the second range is different than the first range; and
if the instruction comprises at least one of the broad spectrum signal, the first range, signal, or the second range signal:
cause the plurality of lamps to generate together a light having a spectral peak, and
cause the plurality of lamps to together vary a wavelength of the spectral peak within the roaming range.

14. The light fixture of claim 13, wherein the first range of the broad spectrum comprises approximately yellowish-green to approximately bluish-green.

15. The light fixture of claim 13, wherein the second range of the broad spectrum comprises at least one of:
approximately cyan to approximately bluish-pink, or
approximately red to approximately orange.

16. The light fixture of claim 13, wherein:
the first range of the broad spectrum comprises approximately yellowish-green to approximately bluish-green; and
the second range of the broad spectrum comprises at least one of:
approximately cyan to approximately bluish-pink, or
approximately red to approximately orange.

17. The light fixture of claim 13, wherein the control portion is further configured to:
if the instruction comprises a third range signal, set the roaming range to a third range of the broad spectrum; and
cause the lamp to vary the wavelength of the spectral peak within the roaming range.

18. The light fixture of claim 17, wherein the third range of the broad spectrum comprises at least one of:
approximately cyan to approximately bluish-pink, or
approximately red to approximately orange.

19. The light fixture of claim 17, wherein:
the first range of the broad spectrum comprises yellowish-green to approximately bluish-green; and
the second range of the broad spectrum comprises approximately cyan to approximately bluish-pink; and
the third range of the broad spectrum comprises approximately red to approximately orange.

20. The light fixture of claim 13, wherein the control portion is further configured to:
if the instruction comprises a first color signal, cause the lamp to generate a light having a spectral peak at a substantially constant wavelength corresponding to the first color, and
if the instruction comprises a second color signal, cause the lamp to generate a light having a spectral peak at a substantially constant wavelength corresponding to the second color.

21. The light fixture of claim 13, further comprising:
a receiver configured to receive a wireless communication including the instruction; and
responsively communicate the instruction with the control portion.

22. The light fixture of claim 21, wherein the wireless communication comprises an infrared communication.
